(19) United States
(12) Patent Application Publication
(10) Pub. No.: US 2009/0168635 A1
(43) Pub. Date: Jul. 2, 2009

(54) Memory Media Including Domains HavingTrapped Charges at a Top Region Thereof

(76) Inventors: QUAN ANH TRAN, Fremont, CA (US); Nathan R. Franklin, San Mateo, CA (US); Qing Ma, San Jose, CA (US); Valluri Rao, Saratoga, CA (US)

Correspondence Address: Laleh Jalali;Intel Corporation, Intel Corporation c/o Intellevate, LLC, P.O. Box 52050, Minneapolis, MN, 55402, US

(21) Appl. No.: 11/964,608

(22) Filed: Dec. 26, 2007

(51) Int. Cl. G11B 9/00; B05D 5/12

(52) U.S. Cl. 369/126; 427/127

(57) ABSTRACT

A memory media and a method to provide same. The memory media includes: a media layer comprising a ferroelectric layer having a bottom surface and a top surface; a plurality of adjacent charge domains defined in the ferroelectric layer, the domains including alternating up domains and down domains each extending between the bottom surface and the top surface; and a trapped charge region adjacent a top surface of the media layer, the trapped charge region including charges in addition to the charges present in the charge domains at regions thereof other than regions adjacent the top surface of the media layer.

### FIELD

Embodiments relate to memory media having charge domains and to methods of stabilizing the domains.

### BACKGROUND

Referring to FIGS. 1a-1c, a schematic representation is provided of a memory media 102 including a ferroelectric layer 104. as seen in FIGS. 1a and 1b, media 102 has domains 106 including UP domains 107 and DOWN domains 109 as shown. Successive UP and DOWN domains 107 and 109 correspond to alternating polarization of bit charges on the media 102. Typically, in their operating environment, domains 106 could change their size as a result of the presence of various unintentionally occurring bias electric fields on the media, which fields would typically bring about domain wall energy minimization as shown in the successive ones of FIGS. 1a, 1b and 1c. An unintentionally occurring bias electric field 111 is shown as being globally present adjacent the bottom surface of the media 102. In the shown figures, bias electric field 111 is pointing up, and could thus have a negative polarity assuming that the bottom surface of the media layer 102 is grounded, as a negative bias polarity usually happens to be the direction of unintentionally occurring bias electric fields present in memory media. However, an unintentional bias electric field could also occur which has a positive polarization, as a function of the arrangement being used. Origins of the unintentional bias electric field are as yet not fully clear. It has been speculated that such fields may occur, among others, as a result of a Schottky barrier present between the bottom electrode (not shown) coupled to the media layer and the material of the media layer, such as the PZT material, and/or as a result of trapped charges at an interface between the bottom electrode and the PZT material.

In the shown arrangement of FIGS. 1a-1c, as shown in FIG. 1b, the DOWN domains 109 shrink as a result of the presence of bias electric field 111, while the UP domains 107 are strengthened by the bias electric field 111, and expand as a result of the same. As the DOWN domains 109 become smaller and smaller, such as, for example, as their thickness reaches a value between about 10 nm and about 15 nm, their shrinking rate accelerates owing to domain wall energy minimization between them and the UP domains 107. Eventually, as shown in FIG. 1c, the DOWN domains may disappear, leaving a single UP domain 107.

FIGS. 1a-1c suggest the instability of a memory media in the presence of unintentional bias electric fields. Such instability tends to manifest especially in the case of domains smaller than about 50 nm. As devices shrink down to domain sizes of 20 nm or less, bringing about a concurrent need for higher data density, techniques to enhance data retention become crucial.

The prior art fails to provide a reliable and cost-effective technique for enhancing data retention in memory media.

### BRIEF DESCRIPTION OF THE DRAWINGS

FIGS. 1a-1c are schematic representations of a media according to the prior art as some of its domains undergo degradation;

FIG. 2 is a schematic representation of a media and of an arrangement to provide the media, according to a first embodiment:

FIG. 3 is a schematic representation similar to FIG. 2, showing a media and an arrangement to provide the media according to a second embodiment;

FIG. 4 is a schematic representation similar to FIG. 2, showing a media and an arrangement to provide the media according to a third embodiment:

FIG. 5 is a flowchart depicting stages of a method embodiment; and

FIG. 6 is a schematic view of an embodiment of a system incorporating a media as shown in FIG. 2, FIG. 3 or FIG. 4.

For simplicity and clarity of illustration, elements in the drawings have not necessarily been drawn to scale. For example, the dimensions of some of the elements may be exaggerated relative to other elements for clarity. Where considered appropriate, reference numerals have been repeated among the drawings to indicate corresponding or analogous elements.

### DETAILED DESCRIPTION

In the following detailed description, a memory media and an arrangement to provide the same are disclosed. Reference is made to the accompanying drawings within which are shown, by way of illustration, specific embodiments by which the present invention may be practiced. It is to be understood that other embodiments may exist and that other structural changes may be made without departing from the scope and spirit of the present invention.

The terms on, above, below, and adjacent as used herein refer to the position of one element relative to other elements. As such, a first element disposed on, above, or below a second element may be directly in contact with the second element or it may include one or more intervening elements. In addition, a first element disposed next to or adjacent a second element may be directly in contact with the second element or it may include one or more intervening elements. In addition, in the instant description, figures and/or elements may be referred to in the alternative. In such a case, for example where the description refers to Figs. X/Y showing an element A/B, what is meant is that Fig. X shows element A and Fig. Y shows element B. In addition, a “layer” as used herein may refer to a layer made of a single material, a layer made of a mixture of different components, a layer made of various sub-layers, each sublayer also having the same definition of layer as set forth above.

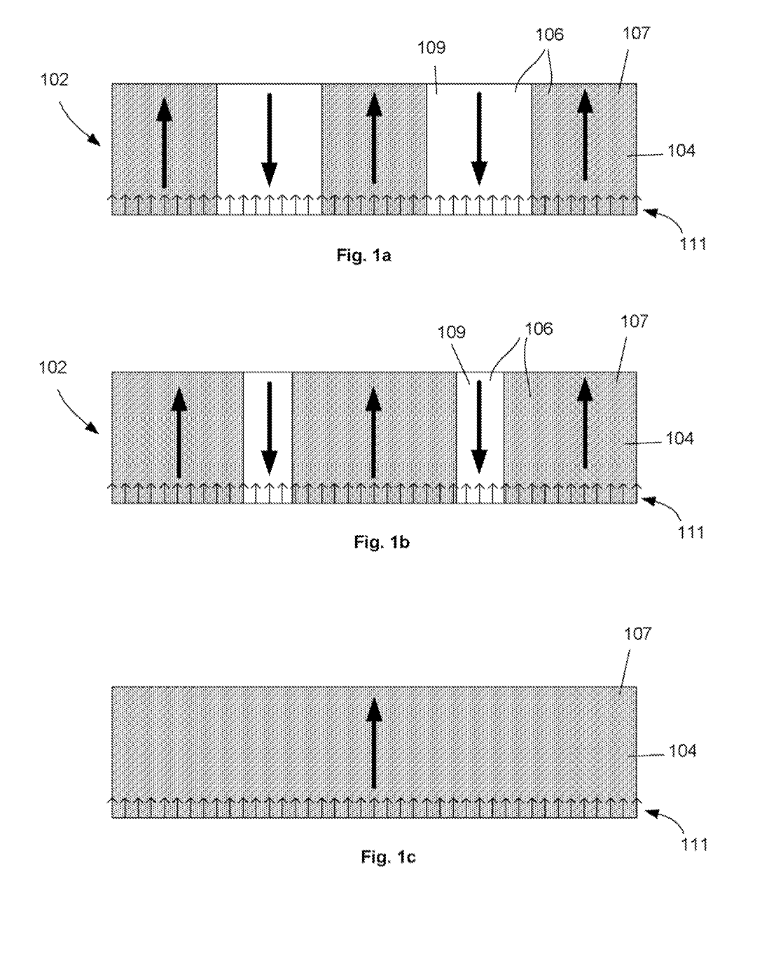

Aspects of this and other embodiments will be discussed herein with respect to FIGS. 1-6 below. The figures, however, should not be taken to be limiting, as they are intended for the purpose of explanation and understanding.

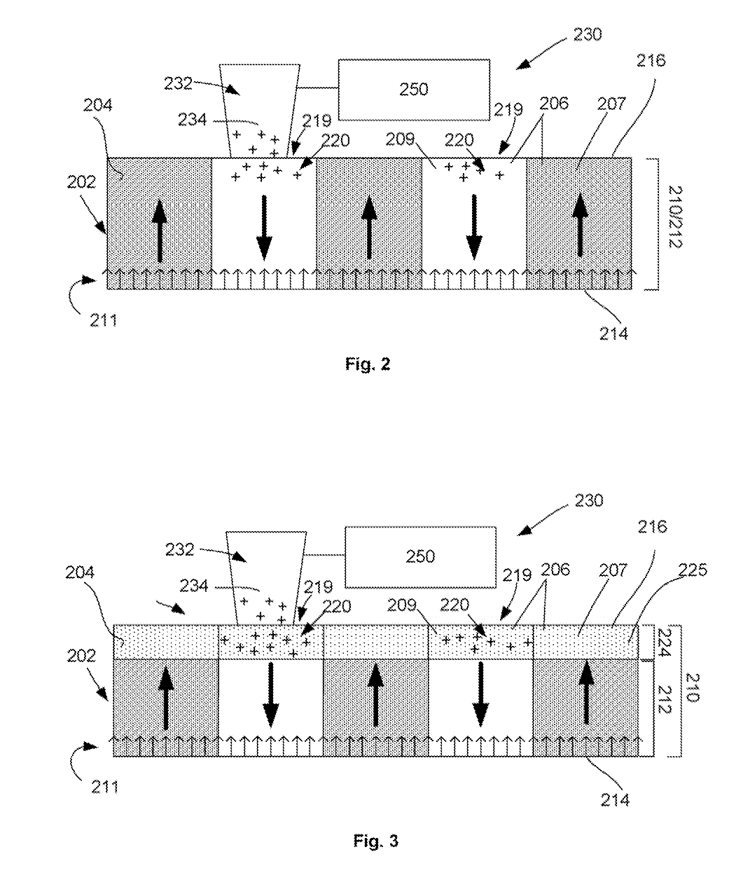

Referring first to FIGS. 2, 3 and 4, a media 202 is shown in an arrangement 230 according to a first embodiment, a second embodiment and a third embodiment, respectively. Arrangement 230 may be effective to provide the media, as will be explained in further detail below. Media 202 comprises a media layer 210 including a memory media, such as the ferroelectric material 204. Media 202 includes one or more domains 206 including bit charges. Domains 206 include UP domains 207 and DOWN domains 209, the UP domains having an opposite charge polarization as compared with the DOWN domains, as would be recognized by one skilled in the art. Each of the domains corresponds to data bits stored in the media. The ferroelectric material 204 may include for example, a PZT material (lead zirconate titinate, or PbZrₓTi₁₋ₓO3, where x ranges from 0.10 to 0.55). Alternative materials for the ferroelectric media may similarly be employed, such as, for example, Bi₃Ti₄O₁₂ and Pb1-ₓLaₓ(Ti_{1-y}Zr_{y})O₃ (i.e., PLZT), where x=0 to 0.2; y=0.1 to 0.55. As seen in FIGS. 2, 3, and 4 an unintentional bias electric field 211 having an upward polarity may be present, although embodiments would include providing a media where a different polarity direction is anticipated for the unintentional bias electric field.

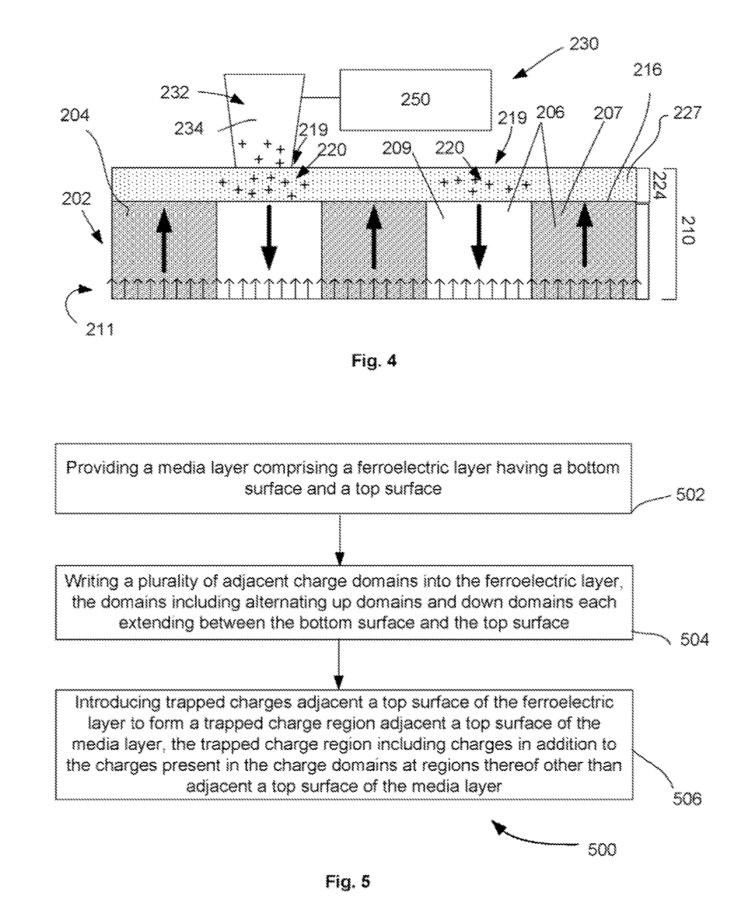

Referring still to FIGS. 2, 3 and 4, the media 202 includes a media layer 210 including a ferroelectric layer 212 having a bottom surface 214 and a top surface 216. In the embodiment of FIG. 24 the media layer 210 and the ferroelectric layer 212 correspond to one another. In the embodiments of FIGS. 3 and 4, on the other hand, the media layer 210 includes not only the ferroelectric layer 2124 but also a charge trapping layer 224 disposed on the top surface 216 of the ferroelectric layer 212, as will be described further below. In the embodiments of FIGS. 2, 3, and 4, the domains 206 extend between the bottom surface 214 and the top surface 216 of ferroelectric layer 212. However, the domains could extend beyond a top surface of the ferroelectric layer, such as, for example, the domains of FIG. 3. As further seen in FIGS. 2, 3 and 4, the media 202 includes a trapped charge region 219 adjacent a top surface of the media layer 210. The trapped charge region 219 includes charges 220 that exist and are trapped in the media in addition to the charges present in the domains at regions of the media other than regions adjacent the top surface thereof. In other words, the trapped charges in the trapped charge region 219 are in addition to the charges present in the media layer that make up the domains 206. These charges are concentrated at a top region of the media layer, as shown in FIGS. 2, 3 and 4. In the shown embodiments, the trapped charge region includes a plurality of positive trapped charge regions 219 contained within the respective ones of the DOWN domains. However, embodiments are not so limited, and include within their scope the provision of additional trapped charges adjacent the top surface of the media layer according to any distribution regime and according to any polarity, including, for example, a distribution regime where the trapped charge region is global, that is, where it is contained within all of the DOWN domains and the UP domains, or a distribution regime where the trapped charge region includes a plurality of trapped charge regions contained within the respective ones of the UP domains, or a distribution and polarity regime where the trapped charge region exists adjacent the top surface of the media as a function of the locations and of the polarity of the bias electric field anticipated to be acting on the media. The locations and polarity of the bias electric field may, for example, be empirically determined, as would be recognized by one skilled in the art.

Referring now in particular to FIGS. 3 and 4, the media layer 210 may further include, as noted above, a charge trapping layer 224 disposed on the top surface 216 of the ferroelectric layer 212. The charge trapping layer 224 may have a trapping density that is higher than a trapping density of the ferroelectric layer 212. In this way, the charge trapping layer 224 may enhance a charge trapping of the media layer adjacent the top surface thereof, thus further improving data retention within the media as compared with a configuration where no charge trapping layer 224 is present, everything else being equal. According to one embodiment, as shown by way of example in FIG. 3, the charge trapping layer 224 is a ferroelectric layer 225. A trapping density of ferroelectric layer 225 may be engineering according to well known methods to achieve a desired trapping density that is higher than a trapping density of ferroelectric layer 212. For example, to engineer the ferroelectric layer 225, defects may be injected into a ferroelectric material to achieve a specific trap density in a manner readily recognized by one skilled in the art. According to another embodiment, as shown for example in FIG. 4, the charge trapping layer 224 is a high dielectric constant, or high-k layer 227, which would advantageously allow effective electric coupling between the media and a writing tip during a writing of charge into the ferroelectric media. A depth of the charge trapping layer 224 may be chosen empirically to be deep enough to allow charge stabilization, but shallow enough to allow charges to be drained from the charge trapping layer when a writing tip switches polarity.

Referring still to FIGS. 2, 3 and 4, the media 202 is shown in conjunction with an arrangement 230 adapted to write bit charges into the same, and is shown in particular in a state where the arrangement 230 has just finished writing the bit regions and introducing additional trapped charges into a top region of the media 202. The arrangement 230 in FIGS. 2, 3 and 4 may allow the practice of a method to provide the media according to respective embodiments. Arrangement 230 may include a probe 232 including tip 234, such as a cantilever tip, and a voltage pulse generator 250 as would be recognized by one skilled in the art. According to embodiments, a tip such as tip 234 may be used to write domains into the ferroelectric layer 212 to achieve a memory domain configuration, such as, for example, the one shown in FIGS. 2, 3 and 4. Method embodiments may then include providing a media layer, such as media layer 210, which comprises ferroelectric layer 212. Prior to the writing of domains into the ferroelectric layer 212, that layer may include a single domain, such as, for example, a single up domain, in its natural state. Method embodiments may further include writing a plurality of adjacent charge domains into the ferroelectric layer 212 by switching the polarity of alternate domain regions in the layer 212. In the shown embodiments of FIGS. 2, 3 and 4, the tip 234 of probe 232 may be used to write the domains in a well known manner. Method embodiments further include introducing trapped charges 220 adjacent the top surface of the media layer to form the trapped charge region 218. According to a preferred embodiment, writing the domains and introducing the trapped charges to form the trapped charge region 218 may both include using the tip 234. Preferably, as to each given domain region, writing and introducing trapped charges are performed and completed before moving onto the next domain region. According to one embodiment, where the ferroelectric layer 212 in its natural state includes an UP domain, and where the unintentional bias electric field is pointing up, for example, tip 234 may be placed over a domain region adapted to serve as a DOWN domain (“DOWN domain region”). At that time, tip 234 may write the DOWN domain into the DOWN domain region to switch the polarity of the charges to a DOWN polarity, therein creating the DOWN domain. During and/or after writing the DOWN domain, the tip 234 may be used to inject further charge into the DOWN domain to create the trapped charge region 219 in that DOWN domain. The tip 234 may then be moved to the next DOWN domain region to write charges therein to create the DOWN domain, and to introduce further charge therein to create another trapped charge region 219 in the same manner as described above. In the alternative, tip 234 may write and form trapped charge regions in all of the DOWN and the UP domains, that is, the trapped charge region may be globally situated at the top region of the media. It is not necessary according to embodiments that the trapped charge region be globally situated, however, to the extent that the domains having the same polarization as the unintentional bias electric field (an UP polarization in the shown figures) would not need a trapped charge region in order to remain stable as long the domains having a polarization opposite that of the unintentional bias electric field are stabilized by virtue of the trapped charges. The above having been said, it may be beneficial to have a globally situated trapped charge region, because trapped charges in domains having the same polarization as the unintentional bias electric field tend to prevent those domains from growing and destabilizing the media. If a globally situated trapped charge region is to be provided, it must be noted, however, that care must be taken in introducing trapped charges into regions having the same polarization as the unintentional bias electric field (in the case of the shown embodiments, the UP domains) that the charges are not large enough to switch the domain polarization to a DOWN polarization. In general, the trapped charge region, whether globally situated or not, tends to advantageously counter balance the effect of the unintentional bias field, resulting in more stable domains. At the same time, the domain having a polarization opposite that of the unintentional bias electric field (in the case of the shown embodiments, the DOWN domains) may exhibit a depolarization field with respect to the unintentional bias electric field that will keep the trapped charge region stable adjacent the top surface of the media.

Referring still to FIGS. 2, 3, and 4, when writing a domain as described above, an optimized voltage pulse may be used so that the peak voltage of the pulse exceeds the threshold voltage for injecting charge into a top layer of the media. The amount of trapped charge thus introduced into the media may be controlled by a magnitude and duration of the pulse. The pulse as plotted versus time may have any suitable configuration according to application needs. A determination of the peak voltage pulse may be achieved using empirical techniques. For example, for a given media layer, the tip may be used to apply various peak voltages for a given pulse configuration and duration. The retention of the bits within the domains may then be observed over time to determine a degradation rate of the domains. A degradation rate of a domain may, for example, be determined by an observation of a reduction in its diameter versus time. In this manner, voltage ranges suitable to both write domains and introduce trapped charges may be narrowed down to finally arrive at an optimum peak voltage. Pulse configuration and duration may further be determined empirically, as would be recognized by one skilled in the manner. The peak voltage may, by way of example, be between about −25V to about +25V, and the pulse duration between about 10 ns to about 1 s.

It is to be noted that, notwithstanding FIGS. 2, 3 and 4, embodiments are not limited to the use of an arrangement where a single tip is used. Thus, an arrangement according to embodiments encompasses within its scope a plurality of probes including probe tips (not shown), such as, for example, tips extending from respective probes in the shape of cantilevers toward the top surface of the media. Such probes may, for example, be arranged in a row or otherwise according to application needs. Additionally, embodiments are not limited to the use of a tip to write domains and introduced trapped charges, but include within their scope any manner of writing domains and introducing charges as would be within the knowledge of the skilled person.

Referring next to FIG. 5, a flowchart 500 is shown of a method of providing a memory media according to embodiments. The method depicted schematically in flowchart 500 may be performed for example using arrangement 230 as shown in FIGS. 2, 3, and 4. At block 502, method embodiments may include providing a media layer comprising a ferroelectric layer having a bottom surface and a top surface. At block 504, method embodiments may further include writing a plurality of adjacent charge domains into the ferroelectric layer, the domains including alternating up domains and down domains each extending between the bottom surface and the top surface. At block 506, method embodiments may include introducing trapped charges adjacent a top surface of the ferroelectric layer to form a trapped charge region adjacent a top surface of the media layer, the trapped charge region including charges in addition to the charges present in the charge domains at regions thereof other than adjacent a top surface of the media layer. Method embodiments may be practiced using the arrangement 230 of FIGS. 2, 3 and 4.

Advantageously, embodiments provide a robust technique for achieving data retention requirements. Embodiments are especially useful in the case of memory media having domain sizes of about 20 nm or less. Embodiments achieve the above by proving a trapped charge region adjacent a top surface of the memory media. The trapped charge region tends to counter balance the effect of an unintentional bias electric field acting on the media, therefore greatly enhancing domain stabilization and data retention. The trapped charge region may have a polarization that is opposite that of the unintentional bias electric field, in this manner generating an electric field that advantageously reinforces the written domain orientation. According to one embodiment, during the domain writing process, a probe tip may inject or introduce positive charges to the top part of the DOWN domains. The positive charges thus trapped would help in reinforcing the DOWN domains, and the DOWN domains would in turn help in holding the positive charges in place. The above mutual reinforcement mechanism would advantageously enhance the stability of the media. Advantageously, according to one embodiment, the top surface of the ferroelectric layer may be provided with a charge trapping layer that is adapted to have a higher trapping density than that of the ferroelectric layer. For example, the charge trapping layer may include a ferroelectric layer that is engineered to have a higher charge trapping density than that of the ferroelectric layer originally used to hold the domains. Alternatively, a high-k material may serve as the charge trapping layer. Advantageously, the provision of a charge trapping layer may further enhance and facilitate the introduction of trapped charges and hence charge retention by the media.

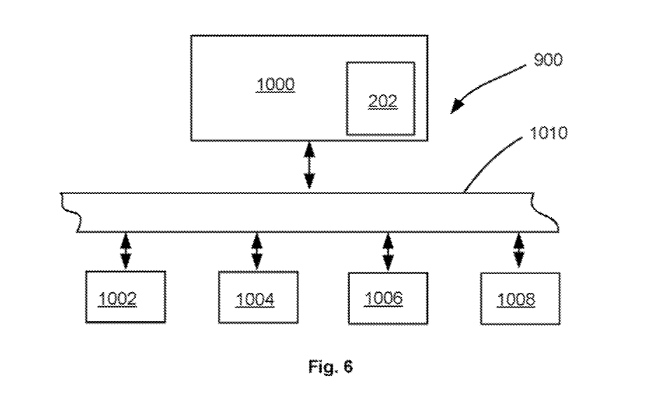

Referring to FIG. 6, there is illustrated one of many possible systems 900 in which embodiments of the present invention may be used. In one embodiment, the electronic assembly 1000 may include a memory media such as media 202 of FIGS. 2, 3, and 4. Assembly 1000 may further include a microprocessor. In an alternate embodiment, the electronic assembly 1000 may include an application specific IC (ASIC). Integrated circuits found in chipsets (e.g., graphics, sound, and control chipsets) may also be packaged in accordance with embodiments of this invention.

For the embodiment depicted by FIG. 6, the system 900 may also include a main memory 1002, a graphics processor 1004, a mass storage device 1006, and/or an input/output module 1008 coupled to each other by way of a bus 1010 as shown. Examples of the memory 1002 include but are not limited to static random access memory (SRAM) and dynamic random access memory (DRAM). Examples of the mass storage device 1006 include but are not limited to a hard disk drive, a compact disk drive (CD), a digital versatile disk drive (DVD), and so forth. Examples of the input/output module 1008 include but are not limited to a keyboard, cursor control arrangements, a display, a network interface, and so forth. Examples of the bus 1010 include but are not limited to a peripheral control interface (PCI) bus, and Industry Standard Architecture (ISA) bus, and so forth. In various embodiments, the system 900 may be a wireless mobile phone, a personal digital assistant, a pocket PC, a tablet PC, a notebook PC, a desktop computer, a set-top box, a media-center PC, a DVD player, and a server.

The various embodiments described above have been presented by way of example and not by way of limitation. Having thus described in detail embodiments of the present invention, it is understood that the invention defined by the appended claims is not to be limited by particular details set forth in the above description, as many variations thereof are possible without departing from the spirit or scope thereof.

What is claimed is:

1. A memory media including:
a media layer comprising a ferroelectric layer having a bottom surface and a top surface;
a plurality of adjacent charge domains defined in the ferroelectric layer, the domains including alternating up domains and down domains each extending between the bottom surface and the top surface;
a trapped charge region adjacent a top surface of the media layer, the trapped charge region including charges in addition to the charges present in the charge domains at regions thereof other than regions adjacent the top surface of the media layer.

2. The media of claim 1, wherein the trapped charge region includes a plurality of trapped charge regions contained within one of respective ones of the up domains and respective ones of the down domains.

3. The media of claim 1, wherein the trapped charge region includes positive charges.

4. The media of claim 2, wherein the trapped charge region includes a plurality of trapped charge regions contained within respective ones of the down domains.

5. The media of claim 1, wherein the media layer includes a charge trapping layer disposed on the top surface of the ferroelectric layer, the charge trapping layer having a higher trapping density than a trapping density of the ferroelectric layer.

6. The media of claim 5, wherein the ferroelectric layer is a first ferroelectric layer, and the charge trapping layer is a second ferroelectric layer disposed on the top surface of the first ferroelectric layer.

7. The media of claim 5, wherein the charge trapping layer is a high-k material.

8. A method to provide a memory media comprising:
providing a media layer comprising a ferroelectric layer having a bottom surface and a top surface;
writing a plurality of adjacent charge domains into the ferroelectric layer, the domains including alternating up domains and down domains each extending between the bottom surface and the top surface;
introducing trapped charges adjacent a top surface of the media layer to form a trapped charge region adjacent the top surface of the media layer, the trapped charge region including charges in addition to the charges present in the charge domains at regions thereof other than adjacent the top surface of the media layer.

9. The method of claim 8, wherein writing and introducing include using a probe having a cantilever tip.

10. The method of claim 9, wherein writing and introducing are performed as to one domain before writing and introducing are performed as to a next domain.

11. The method of claim 9, wherein writing and introducing include using a voltage pulse at the tip, a peak voltage of the pulse exceeding a threshold voltage of introducing charge into each domain.

12. The method of claim 8, wherein the trapped charge region includes a plurality of trapped charge regions contained within one of respective ones of the up domains and respective ones of the down domains.

13. The method of claim 12, wherein the trapped charge region includes a plurality of trapped charge regions including positive charges contained within respective ones of the down domains.

14. The method of claim 8, wherein:
the media layer includes a charge trapping layer disposed on the top surface of the ferroelectric layer, the charge trapping layer having a higher trapping density than a trapping density of the ferroelectric layer;
wherein writing includes writing includes writing into the ferroelectric layer; and
wherein introducing includes introducing charges into the charge trapping layer.

15. The method of claim 14, wherein the charge trapping layer includes one of a ferroelectric layer and a high-k layer.
